(19) United States
(12) Patent Application Publication
(10) Pub. No.: US 2014/0271078 A1
(43) Pub. Date: Sep. 18, 2014

(54) LIFT ARM STRUCTURE WITH AN ARTICULATED KNEE PORTION

(71) Applicant: Rodney Koch, Mooreton, ND (US)

(72) Inventor: Rodney Koch, Mooreton, ND (US)

(21) Appl. No.: 14/143,861

(22) Filed: Dec. 30, 2013

Related U.S. Application Data
(60) Provisional application No. 61/794,448, filed on Mar. 15, 2013.

(51) Int. Cl. B66F 9/22

(52) U.S. Cl. CPC B66F 9/22
USPC 414/723; 414/815

(57) ABSTRACT

A lift arm structure for use on a power machine is disclosed. As disclosed, the lift arm structure includes an articulated knee portion pivotally attached to a main lift arm portion. The articulated knee portion is pivotally coupled to a distal end of the main lift arm portion at a bend angle. The bend angle can be fixed by a fixed length rod connected to the main lift arm portion and the articulated knee portion or adjustable through an actuator operably connected to the main lift arm portion and the articulated knee portion. In some applications, the actuator is a hydraulic cylinder connected to the lift arm portion and the articulated knee portion. A rod of the cylinder is extended and retracted to increase or decrease the bend angle of the articulated knee portion. The bend angle can be adjusted utilizing input from operator input devices or machine controlled utilizing pre-programmed bend angle parameters.

### CROSS-REFERENCE TO RELATED APPLICATION

The present application is based on and claims the benefit of U.S. provisional patent application Ser. No. 61/794,448, filed Mar. 15, 2013, the content of which is hereby incorporated by reference in its entirety.

Disclosed embodiments of the present application have application for power machines having lift arms for carrying implements.

### BACKGROUND

### Field

Power machine such as skid steer loaders, use a lift arm structure to raise and lower an implement. The lift arm structure is pivotally connected to a frame and an actuator or hydraulic cylinder is coupled to the lift arm structure to raise and lower the implement. Lift arm structures can be connected to the frame to provide a vertical lift path or radial lift path for the implement. For use the implement is raised and lowered through the lift arm structure in response to operator input. The operator provides input to manipulate and position the implement for a particular work task. The physical lift arm structure and lift path can restrict height, reach or placement of the implement. The discussion above is merely provided for general background information and is not intended to be used as an aid in determining the scope of the claimed subject matter.

### SUMMARY

The application relates to a lift arm structure for raising and lowering an implement connected to a power machine, such as a skid steer loader. The lift arm structure includes an articulated knee portion pivotally coupled to a main lift arm portion which is connectable to a power machine for use. As disclosed, a proximal end of the main lift arm portion is pivotally coupled to upright frame portions at a rear end of the power machine. The articulated knee portion is pivotally coupled to a distal end of the main lift arm portion at a bend angle so that when the lift arm structure is lowered, the implement is positioned proximate to ground at a forward end of the power machine. The bend angle can be fixed by a fixed length rod connected to the main lift arm portion and articulated knee portion or adjustable through an actuator operably connected to the main lift arm portion and the articulated knee portion. In some applications, the actuator is a hydraulic cylinder connected to the main lift arm portion and the articulated knee portion. A rod of the cylinder is extended and retracted to increase or decrease the bend angle of the articulated knee portion. The bend angle can be operator adjusted utilizing input from operator input devices or machined controlled or adjusted utilizing pre-programmed bend parameters. As disclosed fixed length rods can include pin openings that interface with pin openings on the main lift arm portion and articulated knee portion to interchangeable connect the fixed length rod and the actuator to the lift arm structure. The fixed length rod and actuator form a kit of linkage elements so that the articulated lift arm structure can be used as both a fixed lift arm structure and an adjustable lift arm structure.

This Summary and the Abstract are provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1A is a side view of a skid steer loader type power machine having a vertical lift path.

FIG. 1B is a perspective illustration of a skid steer loader type power machine having a radial lift path.

FIGS. 2A and 2B illustrate embodiments of a lift arm structure having an articulated knee portion.

FIG. 3 schematically illustrates an articulated lift arm structure with an operator adjustable bend angle to provide an operator controlled adjustable lift arm path.

FIGS. 4A and 4B illustrates different left and right joystick configurations having an input device or switch to increase or decrease the bend angle of the articulated knee portion of the articulated lift arm structure

FIG. 5 schematically illustrates an articulated lift arm structure with a machine adjustable bend angle to provide a machine controlled lift arm path.

FIG. 6 is an embodiment of a valve assembly or valve stack for lifting, tilting and adjusting the bend angle of an articulated lift arm structure.

FIG. 7 is a flow chart illustrating steps for adjusting the bend angle of the articulated lift arm structure to provide an adjustable lift arm path.

FIG. 8 illustrates a kit assembly for an articulated lift arm structure for adaption as both a fixed lift arm structure and an adjustable lift arm structure.

### DETAILED DESCRIPTION

The concepts disclosed herein are not limited in their application to the details of construction and the arrangement of components set forth in the following description or illustrated in the following drawings. That is, the embodiments disclosed herein are illustrative in nature. The concepts illustrated in these embodiments are capable of being practiced or being carried out in various ways. The phraseology and terminology used herein is for the purpose of description and should not be regarded as limiting. Words such as “including,” “comprising,” and “having” and variations thereof as used herein are meant to encompass the items listed thereafter, equivalents thereof, as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

FIGS. 1A and 1B illustrate embodiments of representative power machines 100 in which disclosed embodiments of the present application can be employed. The power machines 100 illustrated in FIGS. 1A and 1B are skid loaders, but other types of power machines such as tracked loaders, steerable wheeled loaders, including all-wheel steer loaders, excavators, telehandlers, walk behind loaders, trenchers, and utility vehicles, to name but a few examples, may employ the disclosed embodiments. The power machines in each of the FIGS. 1A and 1B are slightly different machines, but for the purposes of this discussion are represented each as power machine 100. The power machine 100 includes a main frame 102, which supports a power source 104 (illustrated schematically). In some embodiments, the power source 104 is an internal combustion engine operable to supply power to various components of the machine including drive and work components.

As schematically shown, the power source 104 is coupled to a power conversion/delivery system 106 that provides power to various drive and work components of the machine 100. In illustrated embodiments, the power source 104 provides mechanical power which is converted to hydraulic or electrical power to operate various actuators, drive motors or other components of the machine as will be described herein. Illustrative power conversion/delivery components 106 include hydraulic circuitry and devices that provide power to hydrostatic motors and hydraulic actuators. Alternate, power conversion/delivery components 106 employ electric generators or the like to provide electrical power to various component or actuators.

The power machines in FIGS. 1A and 1B include a drive system including tractive elements to move the power machine 100 along a support surface or ground. In FIGS. 1A and 1B, the tractive elements are wheels 108, which are configured to rotatably engage a support surface to allow the power machine 100 to travel in a forward and/or reverse direction. In other examples, the drive system can employ tracks or other tractive elements instead of wheels 108. In an example embodiment, the drive system includes a pair of hydraulic motors (not shown in FIGS. 1A and 1B), which use hydraulic power to generate rotational output to rotate the wheels 108 or other tractive elements. In power machines 100 such as skid steer loaders, a single hydraulic motor can be operatively coupled to both wheels 108 on one side of the power machine 100. Alternatively, a hydraulic motor can be provided for each tractive element or wheel 108 of the power machine 100. In a skid steer loader, steering is accomplished by providing unequal rotational outputs to the tractive element or wheels 108 on one side of the machine as opposed to the other side. In some power machines, steering is accomplished through other means, such as, for example, steerable axles. Applications of the articulated lift arm structures described herein are not limited to machines 100 having powered drive system as shown in FIGS. 1A and 1B.

As shown in FIGS. 1A and 1B, the machine 100 also includes a lift arm structure 110 that is capable of being raised and lowered with respect to the frame 102 to position an implement (not shown in FIG. 1A) for use. In FIG. 1B, the implement is a bucket 112, which is raised and lowered by the lift arm structure 110. The lift arm structure 110 is pivotally attached to a rear end of the frame 102 at attachment point 114. An actuator 116 is coupled to the lift arm structure 110 to raise and lower the lift arm structure 110 to move the implement between a lowered position (shown in FIGS. 1A and 1B) to a raised position. In an illustrated embodiment, the actuator 116 is a hydraulic cylinder pivotally attached to both the frame 102 and the lift arm structure 110 at attachment points 120 and 122, respectively. The hydraulic cylinder is configured to receive pressurized fluid from the power conversion/delivery system 106 to operate the hydraulic cylinder between a retracted and extended position to raise and lower the lift arm structure 110.

As shown in FIG. 1A, an implement carrier 124 is pivotally attached to the lift arm structure 110 at attachment point 126 to attach the implement or bucket 112 (shown in FIG. 1B) to the lift arm structure 110. One or more actuators 130 are pivotally attached to the implement carrier 124 and the lift arm structure 110 to rotate the implement carrier 124 about an axis that extends through the attachment point 126 in an arc approximated by arrow 128. In some embodiments, the one or more actuators 130 include hydraulic cylinders capable of receiving pressurized fluid from the power conversion/delivery system 106 to rotate the implement carrier 124. For example, one or more tilt cylinders, are coupled to the implement carrier 124 to adjust an orientation or tilt of the implement attached to the implement carrier 124. The implement carrier 124 is configured to accept and secure any one of a number of different implements to the power machine 100 as may be desired to accomplish a particular work task.

As previously described and shown in FIG. 1B, a simple bucket 112 can be attached to the implement carrier 124 to accomplish a variety of tasks. A partial list of other types of implements that can be attached to the implement carrier 124 includes augers, planers, graders, combination buckets, wheel saws, and the like. The preceding list includes only a few examples of the many different types of implements that can be attached to power machine 100. As shown in FIG. 1A, the power machine 100 includes an implement interface 132 (only shown in FIG. 1A) to transmit power and control signals from the machine 100 to the implement to control various functions on the implement. In particular, some implements, such as spades, include powered components on the implement. The implement interface 132 connects the powered components on the implement to the power source 104 and power conversion/delivery system 106 on the machine. In one embodiment, the implement interface 132 includes hydraulic couplers (not shown) that are connectable to the implement for providing power in the form of pressurized fluid for use by the implement or alternatively or in addition, the interface 132 includes electrical connectors (not shown in FIGS. 1A and 1B) that can provide power and control signals to the implement to control operation of the powered components on the implement attached to the implement carrier 124.

Power machines 100 also illustratively include a cab 140 that is supported by the frame 102 and defines, at least in part, an operator compartment 142 (not shown in FIG. 1A). Operator compartment 142 typically includes an operator seat and operator input devices 144 (illustrated schematically). When an operator is seated properly within the operator compartment 142, the operator can manipulate the operator input devices 144 to control such functions as driving the power machine 100, raising and lowering the lift arm structure 110, rotating the implement carrier 124 and operating powered components on the implement. Operator input devices 144 can take the form of joystick input devices, levers, foot pedals, switches, actuable devices on a hand grip, pressure sensitive electronic display panels as well as other input devices as appreciated by those skilled in the art.

The lift arm structure 110 of the power machine illustrated in FIG. 1A, implements a vertical lift path as illustrated by arrow 150. As shown, the lift arm structure 110 includes lift arms 152 coupled to upright frame portions 154 on opposed sides of the machine (only one shown in FIG. 1A) through vertical links 156. The upright frame portions 154 are located at a rear end of the machine behind the cab 140. The lift arms 152 include a main lift arm portion 160 and a lift arm knee portion 162. The main lift arm portion 160 is rotationally coupled to link 156 at attachment 164, which is rotationally connected to the upright frame portions 152 at attachment 114. The lift arm knee portion 162 is spaced from link 156 and is located forward of the cab 140 proximate to a front end of the machine 100. As shown, the lift arm knee portion 162 bends downward towards a lower end of the frame 102 at a bend angle to position the implement attached to the implement carrier 124 proximate to the ground when the lift arm structure 110 is in the lowered position. The implement carrier 124 is pivotally connected to the lift arm knee portion 162 at attachment 126. The lift arms 152 of the lift arm structure 110 are raised and lowered via the one or more actuators (or hydraulic cylinders 116) as previously described. As shown, the main lift arm portion 160 includes an elbow 174. A tie rod 176 connects the elbow 175 of the main lift arm portion 160 to the frame 102 to implement the vertical lift path 150 via extension of cylinder 116 in the embodiment shown.

In FIG. 1B, the lift arm structure 110 implements a radial lift path as illustrated by arrow 180. The main lift arm portions 160 of the lift arms 152 are directly connected to the upright frame portions 154 at a rear of the cab 140 and the implement or implement carrier 124 is coupled to the lift arm knee portions 162 forward of the cab 140. The actuators or cylinders 116 (only one shown in FIG. 1B) are connected to the frame 102 and the main portions of the lift arms 160 to raise and lower the implement 112. In the embodiment shown, the actuators are hydraulic cylinders which have a base end connected to the frame 102 and a rod connected to the lift arms 152. Extension and retraction of cylinders 116 rotates the lift arms 152 about attachment 114 to raise and lower the implement carrier 124 or the implement 112 connected to the implement carrier 124.

FIGS. 2A and 2B illustrate embodiments of an articulated lift arm structure 200 which can be used to raise and lower the implement 112 or implement carrier 124 on the power machines illustrated in FIGS. 1A and 1B or other power machines as previously described. As shown, the articulated lift arm structure 200 includes an articulated lift arm knee portion 202 pivotally connected to main lift arm portion 204 at pivot attachment 206. A bend actuator 207 is connected to the main lift arm portion 204 and the articulated knee portion 202 to adjust a bend angle 208 between the main lift arm portion 204 and the articulated knee portion 202 to adjust the lift path for the lift arm structure 200. In some embodiments, the bend angle 208 can be adjusted as the lift arm structure 200 is moved from the lowered position proximate to the ground to the raised position.

As shown, the main lift arm portion 204 includes plate 210 with pin opening 212 and the articulated knee portion 202 similarly includes plate 214 with pin opening 216. In FIG. 2A, the bend actuator 207 is a bend cylinder 220 which is pivotally connected to the main lift arm portion 204 through pin opening 212 in plate 210 on the lift arm portion 204 and pivotally connected to the articulated knee portion 202 through pin opening 214 in plate 216 on the articulated knee portion 202. In the embodiment illustrated in FIG. 2A, the main lift arm portion 204 is coupled to the upright frame portions 154 through links 156 as previously described in relation to FIG. 1A and in contrast, the main lift arm portion 204 of the lift arm structure 200 illustrated in FIG. 1B is directly connected to the upright frame portions 154 similar to FIG. 1B.

FIG. 3 schematically illustrates the articulated lift arm structure 200 and control assembly for manually controlling the bend angle 208 of the articulated lift arm structure 200. In the embodiment shown, the articulated lift arm structure 200 is raised and lowered via lift actuator or cylinder 116 connected to the main lift arm portion 204 and the frame 102. The bend cylinder 220 is connected to the main lift arm portion 204 and the articulated knee portion 202 to adjust the bend angle 208 of the articulated knee portion 202. The tilt cylinder 130 is connected to the articulated knee portion 202 and the implement carrier 124 to adjust the tilt of the implement carrier 124 or implement 112. As shown, the actuators or cylinders 116, 130, 220 are operated based upon lift input 300, tilt input 302 and bend input 304 provided by the user through the operator input devices 144 including a lift input device 306, tilt input device 308 and a bend input device 310. As shown, a machine controller 312 receives the lift input 300, tilt input 302 and bend input 304 and outputs control signals to a valve assembly 314 to supply pressurized fluid from fluid source 316 to extent and retract cylinders 116, 130, 220 based upon the operator input. Thus, as illustrated in FIG. 3, the bend angle 208 of the articulated knee portion 202 is manually controlled utilizing operator input from the operator input devices 144 as described.

As shown, fluid is supplied to a base chamber 320 of cylinder 220 to reduce the bend angle 208 and extend a distal end of articulated knee portion 202 away from the rear end of the power machine. Fluid is supplied to a rod chamber 322 to increase the bend angle 208 between the main lift arm portion 204 and the articulated knee portion 202 to retract a distal end of the articulated knee portion 202 toward the rear end of the power machine 100. The bend angle 208 of the articulated knee portion 202 is adjusted to adjust the lift path. The bend angle 208 can be adjusted while the lift arm structure is in a lowered position and/or adjusted as the lift arm structure 200 moves between the lowered position and the raised position.

FIGS. 4A-4B illustrate the lift, tilt and bend input devices 306, 308, and 310 schematically shown in FIG. 3 implemented through left and right joysticks 330, 332. In FIG. 4A include left and right joysticks 330, 332 are configured in an ISO control pattern. In the ISO control pattern, the left joystick 330 provides drive and steer input and the right joystick 332 provides lift, tilt and bend angle input. As shown, forward and reverse movement 334 of the right joystick 332 provides the lift input to raise and lower the lift arm structure 200 through actuators or cylinders 116 and left/right motion 336 of the joystick 332 provides tilt input 302 to tilt the implement carrier 124 through actuators or cylinders 130.

As shown, joystick 332 includes a rocker switch 340 or other device having multiple positions to increase or decrease the bend angle 208 of the articulated knee portion 202 through actuator 207 or bend cylinder 220. In one embodiment, rocker switch 340 is moved in a forward direction to extend the lift arm knee portion forward and reverse direction to retract the articulated knee portion 202 towards the rear of the machine. In another embodiment, shown in FIG. 4B, the right and left joysticks 330, 332 are configured in an H control pattern. In the H control pattern forward and reverse movement of joysticks 330, 332 control drive and steer and the left joystick 330 control lift and the right joystick 332 controls tilt as shown. As shown joystick 332 includes rocker switch 340 to control the bend angle 208 between the main lift arm portion 204 and the articulated knee portion 202 as previously described with respect to FIG. 4A.

FIG. 5 illustrates an embodiment of the articulated lift arm structure 200 where the bend angle 208 of the articulated knee portion 202 is machined controlled through machine controlled bend component 350. The machine controlled bend component 350 provides input parameters to the machine controller 312 to adjust the bend angle 208 of the articulated knee portion 202. The machine controlled bend component 350 can be configured to adjust the bend angle 208 as the lift arm structure 200 is raised and/or lowered to implement a user selected or machine selected programmed lift arm path. The programmed lift arm path utilized by the controller 312 can be inputted by the user or a default lift path. The input parameters from the machine controlled bend component 350 are used by controller 312 to operate the valve assembly 314 to supplies hydraulic fluid to extend and retract the bend actuator 207 or cylinder 220 to adjust the bend angle 208 of the lift arms according to the programmed lift path.

The machine controlled bend component 350 can provide different bend angle parameters for different lift arm elevations so that the bend angle 208 changes as the lift arm structure is moved from the lowered position to the raised position. The controller 312 and the machine controlled bend component 350 can be a single device including one or more hardware components or embodied in multiple devices. The one or more hardware components include a processor component configured to implement instructions or algorithms stored in memory to provide the bend angle parameters for the programmed lift arm paths implemented by the power machine. In the illustrated embodiment, the controller 312 receives feedback from position sensors 352, 354 on the main lift arm portion 204 and the articulated knee portion 202 to adjust the bend angle as the lift arm structure 200 is raised to implement the programmed lift path selected. The feedback from the position sensors 352, 354 is used to compensate for variations between the demand or input bend angle and the feedback bend angle.

Both the manual and machine control of the bend angle 208 can be implemented on the same power machine utilizing a selectable manual or machine control mode. The manual and machine control modes are selected through a mode selector. The mode selector can be implemented through a graphical user interface or other input device. In an example embodiment, the machine control mode can be a default control mode which is overridden by a user selectable manual control mode.

FIG. 6 is a more detailed illustration of the valve assembly 314 configured to supply pressurized fluid to lift, bend and tilt cylinders 116, 130, 220 of the lift arm structure 200. The valve assembly 314 includes a valve stack having lift, tilt and bend valves 360, 362, 364 connected in series to the fluid source 316. A pump 366 supplies fluid from source 316 to the valve stack and fluid is discharged to tank 368. As shown, the lift valve 360 is first in series and includes a proportional spool 370 that allows for metered flow as the spool moves from an unactuated position to a fully actuated position. By metering flow, partial actuation of a spool valve, in response to the operator input, for example, allows the operator to advantageously control the rate at which an actuator controlled by a proportional spool is operated. Thus, the rate at which a lift arm structure 200 is raised or lowered or an implement carrier 124 is rotated can be controlled.

Valve spool 370 includes a lift position 374 to supply fluid to base chambers of the lift cylinders 116 to raise the lift arms of the lift arm structure 200, a lower position 376 to supply fluid to rod chambers to lower the lift arms of the lift arm structure 200. The valve also includes a float position 378. Fluid from valve 360 is supplied to the tilt valve 362 downstream from valve 360. The tilt valve 362 includes an extended (or dump) position 380 to supply fluid to base chambers of the tilt cylinders 130 and a retracted position 382 to supply fluid to rod chambers of the tilt cylinders 130 to adjust the tilt of the implement carrier 124. Fluid from tilt valve 362 is provided to bend valve 364 to control the bend angle 208 of the articulated knee portion 202. As shown the bend valve 364 includes an extended position 386 that supplies fluid to the base chambers of the bend cylinders 220 to extend the knee portion and a retracted position 388 to supply fluid to the rod chambers of the bend cylinders 220 to pivot the articulated knee portion 202 rearwardly towards the rear end of the machine 100. As shown, fluid is discharged from the valve stack to tank 368. Alternatively, the tilt and bend valves 362, 364 can be connected in parallel as implementation of the valve assembly is not limited to the valve stack shown in FIG. 6.

FIG. 7 is a flow chart illustrating steps for controlling the lift path of a lift arm structure 200. As shown in step 400, the controller 312 receives input parameters for controlling the lift path or bend angle 208 of the articulated knee portion 202 of the lift arm structure 200. In illustrated embodiments, the input parameters are provided through operator input devices 144 or through the machine controlled bend component 350 utilizing preprogrammed bend angle parameters in memory as described. In step 402, the controller 312 utilizes bend parameters provided through the operator input devices 144 or machine controlled bend component 350 to pivot the articulated knee portion 202 to adjust the bend angle 208. In particular, the control outputs from the controller 312 are used to operate the bend cylinder 220 or other actuator to adjust the bend angle 208. For example as shown in FIG. 6, the control ouputs shift the valve position of bend valve 364 to extend or retract rod of the cylinder 220 to adjust the bend angle 208. The controller can provide multiple control signals to adjust the bend angle 208 along the lift path of the lift arm structure 200.

FIG. 8 illustrates a kit for implementing an articulated lift arm structure 200 previously described. As shown, the kit includes a plurality of linkage elements 410 for connecting the main lift arm portions 204 to the articulated knee portions 202. As shown, the linkage elements 410 include the hydraulic cylinder 220 and a fixed length rod 412. Different sized (or length) cylinders 220 or fixed length rods 412 can be used depending upon the specification of the machine and desired bend angle 208. As shown, the hydraulic cylinder 220 includes a base portion and rod portion. The base portion of cylinder 220 include a pin opening 414 to align with pin opening 212 on plate 210 of the main lift arm portions 204 to pivotally connect the base portion to the main lift arm portions 204. The rod portion similarly include a pin opening 416 to connect with the pin opening 214 on plate 216 of the knee portions 202 to pivotally connect the cylinders 220 to the knee portions 202. Pins 418 are inserted through the pin openings 414, 416 on the cylinders 220 and plates 210, 216 to pivotally connect the cylinder 220 to the main lift arm portions 204 and knee portions 202.

As shown the fixed length rod 412 has a fixed length to define a fixed bend angle 208. Different fixed length rods can be used to provide different fixed bend angles 208. Rods 412 similarly include pin openings 414, 416 at opposed ends of the rod. Openings 414, 416 are aligned with openings 212, 214 of the main lift arm portion 204 and the articulated knee portion 202 to connect the first end of the rod to the main lift arm portion 204 and the second end of the rod to the articulated knee portion 202. As described, pins 418 extend through openings 414, 416, 212, 216 to connect the rods to the main lift arm portions 204 and the articulated knee portions 202. Although a particular attachment mechanism is shown, application is not limited to a particular attachment mechanism for the cylinder 220 or the fixed length rod 412. Thus as described, the lift arm structure 100 can be used to provide an adjustable lift path or lift arm structure via control of the bend angle 208 or can be adapted to provide a lift path having a fixed bend angle.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. Although the application describes use of hydraulic cylinders, application is not limited to hydraulic cylinders and other actuators such as pneumatic or electric actuators can be utilized to adjust the bend angle as described.

What is claimed is:

1. A lift arm assembly for attachment to a power machine having a frame and a front end and a rear end wherein the lift arm assembly includes a lift arm structure configured to be pivotally attached to the frame and movable between a lowered position and a raised position comprising:
a main lift arm portion having a proximal end pivotally attachable to the frame;
an articulated knee portion having a first end pivotally coupled to a distal end of the main lift arm portion and a second end spaced from the first end; and
wherein a length of the main lift arm portion is configured to extend from the pivotal attachment to the frame proximate to the rear end of the machine proximate to the front end of the machine and the articulated knee portion is configured to extend from the main lift arm portion at a bend angle proximate to the front end of the machine.

2. The lift arm assembly of claim 1 and comprising an actuator coupled to the main lift arm portion and the articulated knee portion to adjust the bend angle between the main lift arm portion and the articulated knee portion.

3. The lift arm assembly of claim 2 wherein the actuator is a cylinder configured to receive pressurized fluid to extend or retract a rod coupled between the main lift arm portion and the articulated knee portion to adjust the bend angle.

4. The lift arm assembly of claim 3 wherein the cylinder includes pin openings at a base end and rod end and is connected to the main lift arm portion and the articulated knee portion through pins insertable through the pin openings of the cylinder and pin openings on the main lift arm portion and the articulated knee portion.

5. The lift arm assembly of claim 1 where the lift arm structure includes an actuator pivotally attached to the main lift arm portion and connected to the frame to move the lift arm structure from the lowered position to the raised position.

6. The lift arm assembly of claim 2 and comprising an implement carrier pivotally attached to the lift arm knee portion and an actuator coupled to the lift arm knee portion and the implement carrier to adjust a tilt of the implement carrier relative to the articulated knee portion.

7. The lift arm assembly of claim 2 and comprising a controller assembly coupled to the actuator and configured to utilize input from one or more operator input devices to provide control signals to operate the actuator to adjust the bend angle responsive to the input from the one or more operator input devices.

8. The lift arm assembly of claim 2 and comprising a machine controlled bend component configured to provide preprogrammed bend parameters to a controller coupled to the actuator to adjust the bend angle utilizing the preprogrammed bend parameters.

9. The lift arm assembly of claim 8 including position sensors on the main lift arm portion and the articulated knee portion to provide position feedback to the controller to implement the preprogrammed bend parameters from the machine controlled bend component.

10. A method comprising:
receiving an input bend angle for a lift arm structure having an articulated knee portion pivotally connected to a main lift arm portion pivotally coupleable to a frame; and
pivoting the articulated knee portion relative to the main lift arm portion to adjust a bend angle between the main lift arm portion and the articulated knee portion to the input bend angle.

11. The method of claim 10 wherein the step of receiving the input bend angle comprises receiving the input bend angle from one or more operator input devices.

12. The method of claim 10 wherein the step of receiving the input bend angle comprises receiving preprogrammed bend parameters from a machine controlled bend component.

13. The method of claim 10 and comprising:
receiving input from sensors on the main lift arm portion and the articulated knee portion to provide a feedback bend angle; and
pivoting the articulated knee portion to adjust the bend angle to compensate for variations between the feedback bend angle and the input bend angle.

14. The method of claim 10 wherein the bend angle between the main lift arm portion and the articulated knee portion is controlled utilizing input from one or more operator input devices in a user control mode and utilizing preprogrammed bend parameters from a machine controlled bend component in a machine control mode and comprising:
receiving an input to implement the user control mode or the machine control mode.

15. The method of claim 10 wherein an implement carrier is coupled to a distal end of the articulated knee portion spaced from the pivotal connection and comprising:
adjusted a tilt angle of the implement carrier relative to the articulated knee portion.

16. The method of claim 10 and comprising:
lifting the main lift arm portion from a lowered position to a raised position; and
pivoting the articulated knee portion to adjust the bend angle as the main lift arm portion moves from the lowered position to the raised position.

17. The method of claim 16 wherein the step of pivoting the articulated knee portion to adjust the bend angle comprises:
pivoting the articulated knee portion to adjust the bend angle between the main lift arm portion and the lift arm knee position to define different bend angles at multiple elevations between the lowered position and the raised position.

18. A kit for use with a lift arm structure for a power machine provided with an articulated knee portion pivotally connected to a main lift arm portion, the kit comprising:
a linkage element configured to link the articulated knee portion pivotally connected to the main lift arm portion to the main lift arm portion at a bend angle.

19. The kit of claim 18 comprising a plurality of linkage elements including:
at least one actuator having first end connectable to the articulated knee portion and a second end connected to the main lift arm portion to link the articulated knee portion to the main lift arm portion at an adjustable bend angle to provide an adjustable lift arm structure; and
at least one rod having a first end connectable to the main lift arm portion and a second end connectable to the articulated knee portion to link the articulated knee portion to the main lift arm portion at a fixed bend angle to provide a fixed lift arm structure.

20. The kit of claim of claim 18 wherein the linkage element comprises a hydraulic cylinder including pin openings at first and second ends and the first end connectable to the main lift arm portion through a first pin insertable through the pin opening at the first end of the cylinder and pin opening on the main lift arm portion and the second end is connectable to the articulated knee portion through a second pin insertable through the pin opening at the second end of the cylinder and pin opening on the articulated knee portion.
